(19) United States
(12) Patent Application Publication
(10) Pub. No.: US 2014/0326385 A1
(43) Pub. Date: Nov. 6, 2014

(54) Pneumatic Tire

(71) Applicant: THE YOKOHAMA RUBBER CO., LTD., Minato-ku, Tokyo (JP)

(72) Inventor: Hiroyuki Sato, Hiratsuka-shi (JP)

(73) Assignee: The Yokohama Rubber Co., LTD., Minato-ku, Tokyo (JP)

(21) Appl. No.: 14/358,677

(22) PCT Filed: Nov. 5, 2012
(86) PCT No.: PCT/JP2012/007078

§ 371 Date: May 15, 2014

(30) Foreign Application Priority Data
Nov. 15, 2011 (JP) 2011-249499

(51) Int. Cl. B60C 13/02

(52) U.S. Cl. CPC B60C 13/02
USPC 152/523

(57) ABSTRACT

The side wall portion of the pneumatic tire has a pattern formed by linear portions extending without intersecting each other along a first direction A that is the tire radial direction or the tire circumferential direction with gaps in a second direction B that is the tire radial direction or the tire circumferential direction. The linear portions include inclined pattern portions that extend inclined with respect to direction A. Ends of the inclined pattern portions on a first side in direction B are aligned in direction A, and ends on a second side in direction B are aligned in direction A, and, between the inclined pattern portions provided on linear portions that are adjacent in direction B, the ends on a first side in direction A are aligned in direction B, and the ends on a second side in direction A are aligned in direction B.

### TECHNICAL FIELD

The present technology relates to a pneumatic tire having a side wall portion.

### BACKGROUND

In recent years, the side wall thickness (hereinafter, also referred to as the side gauge) of pneumatic tires has been made thinner in order to achieve reduction in weight and low rolling resistance. However, if the side gauge is made thin, appearance flaws tend to occur at high probability on the side wall surfaces. These appearance flaws do not have any adverse effect on the tire durability or driving performance, but users are concerned whether these flaws might indicate low tire durability or driving performance.

Specifically, in the molding process during tire manufacture, the sheet-like carcass member is wound once around the tire forming drum, and the winding starting end and the winding finishing end are partially overlapped to form a joint. Therefore, the thickness of the overlapping portion is greater, and this portion appears as unevenness on the side wall surface on the finished tire. In particular, in radial tires that use one carcass member, this unevenness is very pronounced.

On the other hand, a pneumatic tire in which the unevenness of the side wall surface of the tire is not conspicuous is known (Japanese Unexamined Patent Application Publication No. 2011-37388A).

In a decorative portion that extends band-like in the circumferential direction on the outer surface of the pneumatic tire described above, a first ridge group and a second ridge group are formed each including a plurality of ridges disposed at a predetermined pitch extending in the tire radial direction. Each ridge of the first ridge group and each ridge of the second ridge group intersect forming a moire pattern, so the unevenness on the side wall surface is not conspicuous.

However, there are various methods besides the technology described in Japanese Unexamined Patent Application Publication No. 2011-37388A to ensure that the unevenness in the side wall surface of pneumatic tires is not conspicuous, and there is a demand for further improvements in technology or methods to make the unevenness sufficiently inconspicuous.

### SUMMARY

The present technology provides a pneumatic tire in which the unevenness of the side wall surface is sufficiently inconspicuous.

An aspect of the present technology is a pneumatic tire having a side wall portion.

The pneumatic tire includes: a tread portion; a bead portion; and a side wall portion. The side wall portion has a pattern that can be visually distinguished from the surrounding area due to recesses and protrusions of the side wall surface or light reflection properties, and the pattern is configured by providing a plurality of linear portions extending without intersecting each other along a first direction A that is either the tire radial direction or the tire circumferential direction with gaps in a second direction B that is either the tire radial direction or the tire circumferential direction

Each of the plurality of linear portions includes a plurality of inclined pattern portions extending in a direction that is inclined with respect to the direction A.

Each of the plurality of inclined pattern portions is provided so that the positions of ends on a first side in the direction B are aligned with each other in the direction A, and the positions of ends on a second side in the direction B are aligned with each other in the direction A, and, between the inclined pattern portions provided on linear portions that are adjacent in the direction B, the positions of the ends on a first side in the direction A are aligned in the direction B, and the positions of the ends on a second side in the direction A are aligned in the direction B.

Preferably, the gaps in the direction B of the plurality of linear portions vary periodically.

Also, preferably, the length in the direction A of the plurality of inclined pattern portions varies periodically.

Preferably, each of the plurality of inclined pattern portions has a surface roughness that is different from that of the surrounding area, and, is formed by arranging a plurality of small 4-sided shaped areas each having the same surface roughness in a direction that is inclined with respect to the direction A.

The small areas are rectangular-shaped areas, and each of the inclined pattern portions is formed by arranging one side of the small area along the direction A and arranging the plurality of small areas in step form along the direction A.

Preferably, the surface roughness Ra of the area of the side wall surface without the pattern satisfies the relationship Ra1>Ra>Ra2, where Ra1 is the surface roughness of first inclined pattern portions from among the plurality of inclined pattern portions, and Ra2 is the surface roughness of second inclined pattern portions that are adjacent to the first inclined pattern portions in the direction A.

Preferably, the plurality of small areas is in point contact or line contact with each other when the side wall surface is viewed.

Also, preferably, the difference between the surface roughness Ra1 of the first inclined pattern portions and the surface roughness Ra2 of the second inclined pattern portions is different every plurality of linear portions and varies periodically along the direction B.

Also, preferably, in addition to the inclined pattern portions, the linear portions include a straight portion that extends in a straight line along the direction A, the inclined pattern portions intersect with the straight portion, and the straight portion and the inclined pattern portions are provided protruding from or recessed into the side wall surface.

Also, preferably, in addition to the inclined pattern portions, the linear portions include a straight portion that extends in a straight line along the direction A, the inclined pattern portions intersect with the straight portion, and the light reflection properties of the surfaces of the straight portion and the inclined pattern portions are different from the light reflection properties of the surfaces around the linear portions.

Preferably, the light reflection properties are diffuse reflection properties, and the extent of diffuse reflection of the surfaces of the straight portion and the inclined pattern portions is greater compared with the extent of diffuse reflection of the surface around the linear portions.

Preferably, the surface roughness of the straight portion and the inclined pattern portions is greater compared with the surface roughness of the surface around the linear portions.

According to the pneumatic tire of the present technology, it is possible to make the unevenness of the side wall surface sufficiently inconspicuous.

### BRIEF DESCRIPTION OF THE DRAWINGS

FIG. 1 illustrates the surface of a side wall portion of a pneumatic tire according to a first embodiment.

FIG. 2 is a meridian cross-sectional view illustrating a portion of the pneumatic tire according to the first embodiment.

FIG. 3 is an explanatory view of the overlap in the carcass member which is the cause of the unevenness that appears on the side wall surface of the tire.

FIGS. 4A to 4C are explanatory views of examples of patterns formed in the side wall surface of the pneumatic tire according to the first embodiment.

FIGS. 5A and 5B illustrate examples of the cross-section of a linear portion.

FIGS. 6A and 6B are explanatory views of an example of very fine unevenness in the linear portion.

FIG. 7 illustrates the surface of the side wall portion of the pneumatic tire according to a second embodiment.

FIGS. 8A to 8C are explanatory views of the linear portion of the pattern formed in the side wall surface of the pneumatic tire according to the second embodiment.

FIGS. 9A and 9B are explanatory views of examples of the pattern formed in the side wall surface of the pneumatic tire according to the second embodiment.

FIGS. 10A and 10B are explanatory views of another example of the pattern depicted in FIG. 9.

FIGS. 11A and 11B are explanatory views of another example of the linear portion depicted in FIG. 8.

FIG. 12 is an explanatory view of an example of the pattern formed in the side wall surface of the pneumatic tire according to a third embodiment.

FIG. 13 is an explanatory view of an example of the pattern formed in the side wall surface of the pneumatic tire according to a fourth embodiment.

FIG. 14 is an explanatory view of an example of the pattern formed in the side wall surface of the pneumatic tire according to a fifth embodiment.

### DETAILED DESCRIPTION

The following is a detailed description of the pneumatic tire according to the present technology. In the following, the tire circumferential direction refers to the rolling direction of the tread portion when the tread portion is rotated about the tire rotational axis, and the tire radial direction refers to the direction that extends radiating from the tire rotational axis.

### First Embodiment

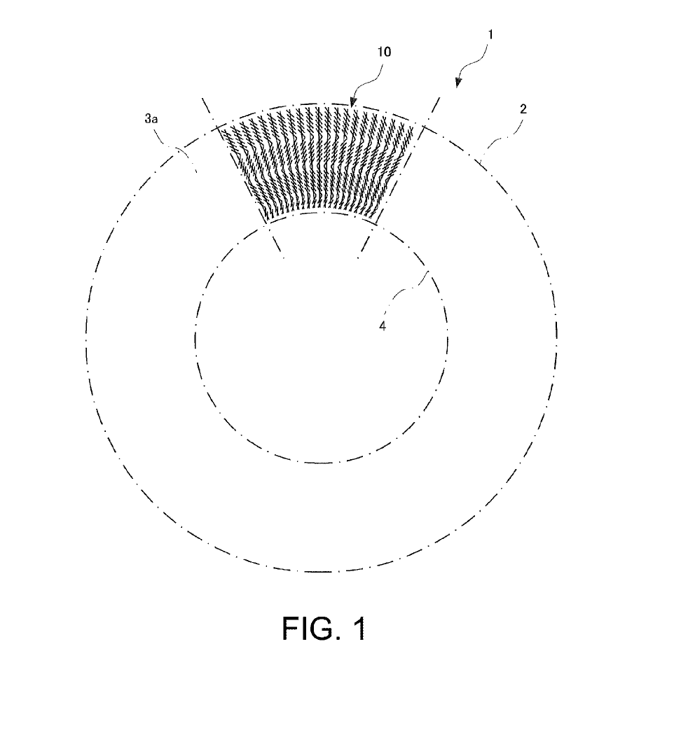

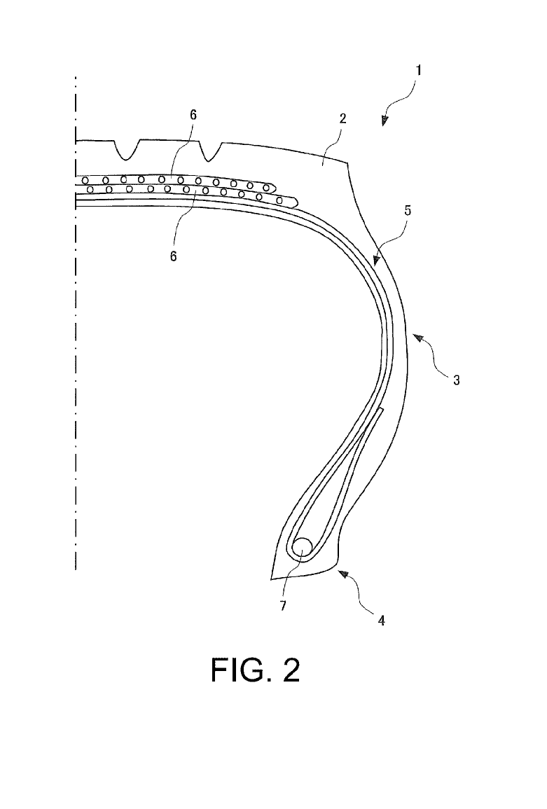

FIG. 1 illustrates the surface of a side wall portion 3 (see FIG. 2) of a pneumatic tire (hereinafter, referred to as tire) 1 according to a first embodiment. In FIG. 1, a tread portion 2 is shown as a circular arc chain dotted line, and a bead portion 4 is shown as a circular arc chain dotted line.

As illustrated in FIG. 2, the tire 1 includes the tread portion 2, the side wall portion 3, the bead portion 4, a carcass layer 5, and a belt layer 6. FIG. 2 is a meridian cross-sectional view illustrating a portion of the tire 1. In addition, the tire 1 includes an inner liner layer, and the like, that are not illustrated in the drawings. Also, the bead portion 4 includes a bead core 7. The side wall portion 3 and the bead portion 4 are disposed as pairs on both sides of the tire width direction sandwiching the tread portion 2.

As illustrated in FIG. 1, the side wall portion 3 includes a side pattern display area 3a, and an emblem display area (not illustrated in the drawings) provided on the tire circumference. In the emblem display area, the tire product name, brand name, tire manufacturer's name, size, and the like are displayed as characters, symbols, or numerals, or similar. The side pattern display area 3a is provided surrounding the emblem display area. The side pattern display area 3a as described below may be provided on the side wall portion 3 on one side in the width direction of the tire 1, or it may be provided on the side wall portion 3 on both sides in the width direction of the tire 1

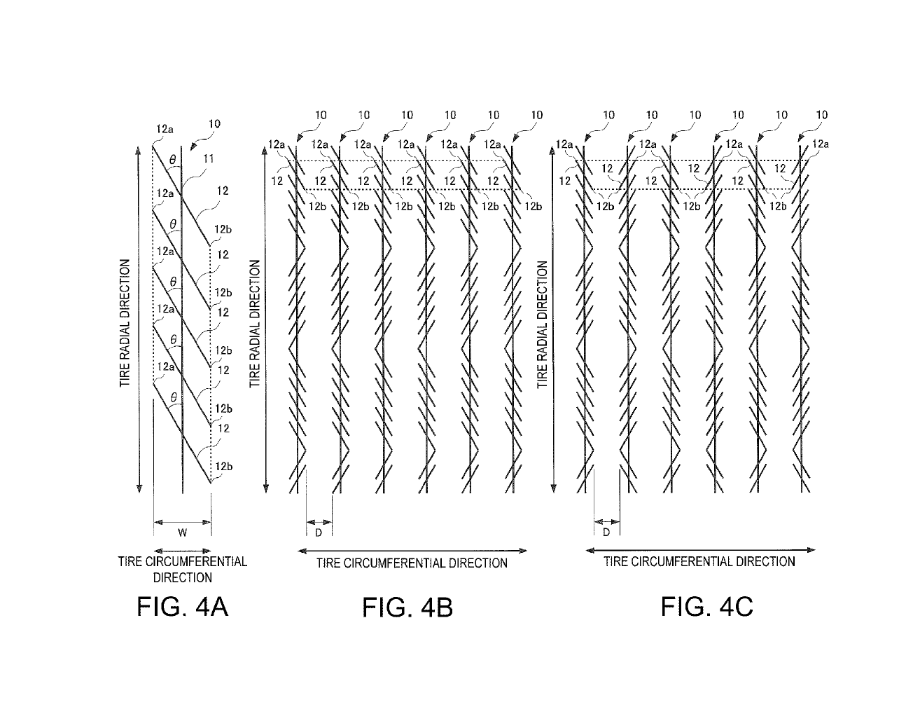

The side pattern display area 3a of the side wall surface includes a pattern that can be visually distinguished from the surrounding area by recesses and protrusions of the side wall surface or by its light reflective properties. As illustrated in FIG. 1, this pattern includes a plurality of linear portions 10 extending along the radial direction, and each of the linear portions 10 is formed at a pitch D in the tire circumferential direction without intersecting each other (see FIGS. 4B and 4C).

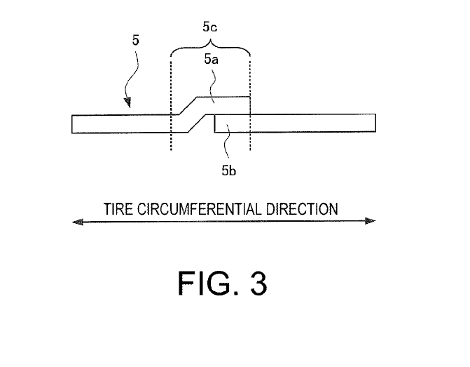

This pattern is provided so that the unevenness appearing on the side wall surface is not conspicuous, as a result of a person viewing the tire 1 receiving a visual illusion by this pattern. The unevenness appearing on the side wall surface is formed by, for example, a step being formed along the tire radial direction by the carcass layer 5 winding finishing end 5a and winding starting end 5b overlapping in an area 5c, as illustrated in FIG. 3.

Next, the pattern of the side pattern display area 3a is described in detail with reference to FIG. 4. FIGS. 4A to 4C are explanatory views of examples of the pattern formed on the side wall surface. In the following drawings, the tire radial direction and the tire circumferential direction are shown for convenience corresponding to the vertical direction and the horizontal direction in the plane of the paper, but the tire radial direction and the tire circumferential direction are the directions as defined above.

As illustrated in FIG. 4A, the linear portion 10 includes a straight portion 11 and a plurality of inclined pattern portions 12. The straight portion 11 and the plurality of inclined pattern portions 12 are formed so that they can be visually distinguished from the surrounding area by recesses and protrusions or the light reflection properties of the side wall surface as described below. The length of the linear portion 10 in the tire radial direction may be set as appropriate in accordance with the length in the tire radial direction of the side pattern display area 3a, and, for example, is preferably from 30 to 80% of the length in the tire radial direction of the side pattern display area 3a. Also, the width W in the tire circumferential direction of the linear portion 10 is preferably from 1.0 to 5.0 mm, for example.

The straight portion 11 is formed so that it extends linearly along the tire radial direction. Each of the plurality of inclined pattern portions 12 intersects the straight portion 11, and includes two ends 12a, 12b on both sides of the straight portion 11. Each of the plurality of inclined pattern portions 12 is formed extending linearly in a direction inclined with respect to the direction that the straight portion 11 extends, namely, the tire radial direction. Each of the plurality of inclined pattern portions 12 need not necessarily be formed linearly, but may be formed as a curved line or a wavy line, for example. Also, each of the plurality of inclined pattern portions 12 is provided so as to intersect with the straight portion 11 at the center. In addition, as illustrated in FIG. 4A, the absolute value of the acute angle θ formed by each of the plurality of inclined pattern portions 12 and the straight portion 11 is preferably greater than 0° and equal to or less than 45°. Also, in the tire 1 according to this embodiment, the width of each of the plurality of inclined pattern portions 12 (the width in the direction orthogonal to the inclination direction) is formed the same as the width in the tire circumferential direction of the straight portion 11, but it may also be formed smaller or larger than the width in the tire circumferential direction of the straight portion 11. Also, the plurality of inclined pattern portions 12 may be provided so that they are each in the same inclined direction with respect to the tire radial direction, and the plurality of inclined pattern portions 12 may be provided so that, for example as illustrated in FIGS. 4B and 4C, the inclination direction with respect to the tire radial direction is inverted about the tire circumferential direction every predetermined number of inclined pattern portions 12. Here, inverting the inclination direction about the tire circumferential direction refers to the inclination direction of the inclined pattern portions 12 after inversion having an orientation direction that has line symmetry with respect to the inclined pattern portions 12 before inversion with respect to the tire radial direction. Specifically, in the patterns illustrated in FIGS. 4B and 4C, when the tire radial direction is the vertical direction, in a single linear portion 10, the inclination direction of the 1st to the 6th inclined pattern portions 12 from the top are inclined in the downward to the right direction, but the inclination direction of the 7th to the 12th inclined pattern portions 12 from the top are inclined in a direction with linear symmetry about the tire radial direction to the downward to the right inclination direction, namely they are inclined in the downward to the left direction.

Also, as illustrated in FIG. 4A, the positions of the ends 12a on a first side in the tire circumferential direction of each of the plurality of inclined pattern portions 12 are provided so as to be aligned in the tire radial direction, and the positions of the ends 12b on a second side in the tire circumferential direction are provided so as to be aligned in the tire radial direction. Here “aligned” means that the absolute value of the acute angle formed by the line connecting at least two ends 12a of the ends 12a on the first side in the tire circumferential direction of each of the plurality of inclined pattern portions 12 (or the line connecting at least two ends 12b of the ends 12b on the second side in the tire circumferential direction of each of the plurality of inclined pattern portions 12) and the straight line extending in the tire radial direction (indicated as broken lines in FIG. 4A) is 10° or less, including an absolute value of 0°.

Next, the relationship between the plurality of linear portions 10 is described with reference to FIGS. 4B and 4C. As described previously, each of the linear portions 10 is provided without intersecting each other and with a gap D therebetween in the tire circumferential direction. The gap D varies depending on the position in the tire radial direction in accordance with a constant angle of view with the tire rotational axis as center. Also, the gap D represents the distance in the tire circumferential direction between an end 12b on the second side in the tire circumferential direction of the plurality of inclined pattern portions 12 on one linear portion 10, and an end 12a on the first side in the tire circumferential direction of the plurality of inclined pattern portions 12 in another linear portion 10 that is adjacent to the linear portion 10 in the tire circumferential direction. Preferably, the gap D is formed greater than the width W in the tire circumferential direction of the linear portion 10 at the same position in the tire radial direction. Also, as illustrated in FIGS. 4B and 4C, between each of the plurality of inclined pattern portions 12 of the linear portion 10 and the inclined pattern portion 12 provided on another adjacent linear portion 10 with the gap D in the tire circumferential direction therebetween, the ends 12a on the first side in the tire radial direction are aligned in the tire circumferential direction, and the ends 12b on the second side in the tire radial direction are aligned in the tire circumferential direction.

Also, the inclination direction of one inclined pattern portion 12 of one linear portion 10 and the inclination direction of an inclined pattern portion 12 of another adjacent linear portion 10 with the gap D therebetween in the tire circumferential direction may be the same, as shown in FIG. 4B, or they may be inverted with respect to each other about the tire circumferential direction, as shown in FIG. 4C. If the inclination direction of each of the plurality of inclined pattern portions 12 of the linear portion 10 is the same as each other, preferably, the inclination direction of the plurality of inclined pattern portions 12 and the inclination direction of the plurality of inclined pattern portions 12 of another linear portion 10 that is adjacent to the linear portion 10 with the gap D in the tire circumferential direction are inverted with respect to each other about the tire circumferential direction.

In the pattern of the example illustrated in FIG. 4B, when the plurality of inclined pattern portions 12 is viewed in sequence along the tire radial direction, after six consecutive inclined pattern portions 12 in the same inclination direction, six consecutive inclined pattern portions 12 are inverted, and thereafter, the inclination direction is again inverted for six consecutive inclined pattern portions 12. This type of linear portion 10 is disposed continuously in the tire circumferential direction.

Also, in the pattern of the example illustrated in FIG. 4C, when the plurality of inclined pattern portions 12 is viewed in sequence along the tire radial direction, after six consecutive inclined pattern portions 12 in the same inclination direction, six consecutive inclined pattern portions 12 are inverted, and thereafter, the inclination direction is again inverted for six consecutive inclined pattern portions 12. This type of linear portion 10 is disposed continuously in the tire circumferential direction, but the inclination direction of the inclined pattern portions 12 is inverted between the inclined pattern portions 12 of adjacent linear portions 10.

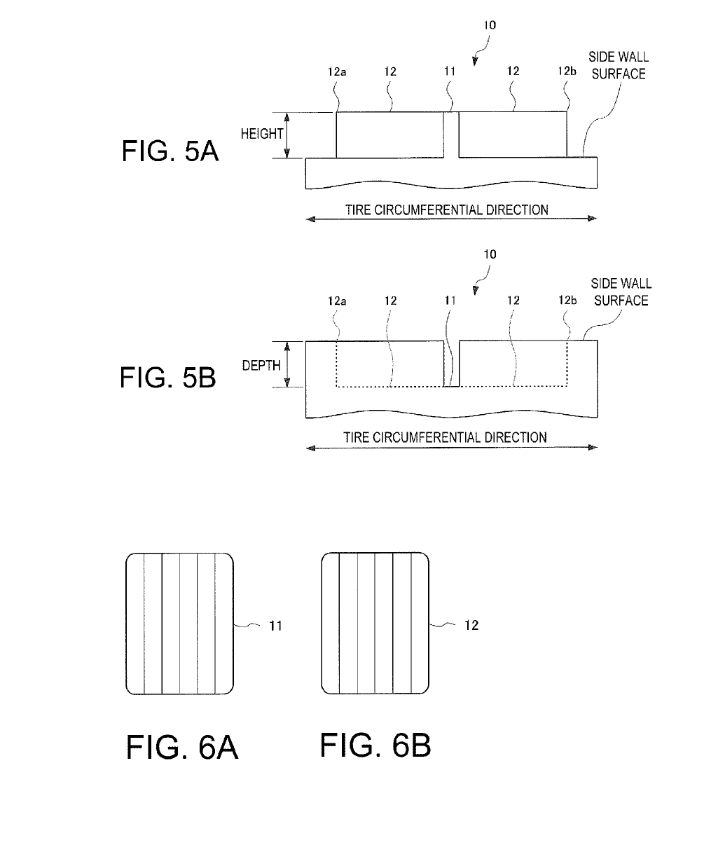

FIGS. 5A and 5B illustrate examples of the cross-section of the linear portion 10. In the examples illustrated in FIGS. 5A and 5B, the surface of the linear portion 10 has recesses and protrusions, so the pattern that includes the linear portion 10 can be visually distinguished from the surrounding areas.

As illustrated in FIG. 5A, if the pattern is formed with protrusions, the straight portion and the plurality of inclined pattern portions 12 of the linear portion 10 are provided protruding from the side wall surface. Also, as illustrated in FIG. 5B, if the pattern is formed with recesses, the straight portion and the plurality of inclined pattern portions 12 of the linear portion 10 are provided recessed from the side wall surface. Preferably, the height from the side wall surface of the linear portions 10 when the pattern is formed with protrusions, or the depth from the side wall surface of the linear portions 10 when the pattern is formed with recesses is from 0.3 mm to 3.0 mm, in order to give viewers an effective visual illusion, so that the unevenness appearing on the side wall surface is not conspicuous.

The height or the depth of the linear portions 10 with respect to the side wall surface may be the same in each of the plurality of linear portions 10, or they may be different.

FIGS. 6A and 6B are explanatory views of a preferred form of the surface of the linear portion 10. Regardless of whether the linear portions 10 are formed with protrusions or recesses, the surface of the linear portions 10, in other words, the surface of the straight portion 11 and the plurality of inclined pattern portions 12, may be configured from a serration processed fine corrugated surface using a plurality of ridges arranged in the same direction. At this time, the processing of the serrations of the straight portions 11 and the plurality of inclined pattern portions 12 should be such that the density of the ridges is the same, as illustrated in FIGS. 6A and 6B. In this way, the light incident on the surface of the straight portions 11 and the plurality of inclined pattern portions 12 is diffusely reflected, or the extent of diffuse reflection is high compared with the surroundings of the linear portions 10. Therefore, the amount of the light entering the field of view of a viewer that has been diffusely reflected at the surface of the linear portions 10 is less than the amount of the light entering the field of view of a viewer that has arrived from the surroundings of the linear portions 10. Therefore, the linear portions appear darker than the surroundings of the linear portions 10, so it is possible to more effectively visually distinguish the linear portions 10 from their surroundings. In this case, the density of ridges in the straight portions 11 and in the plurality of inclined pattern portions 12 is, for example, 1 ridge/mm to 2 ridges/mm.

Also, by providing a plurality of ridges, it is difficult for dead air space to occur in the vulcanization process of the tire manufacturing stage, so it is possible to reduce the rate of occurrence of appearance flaws.

In this embodiment, the straight portions 11 and the plurality of inclined pattern portions 12 are formed by providing surface recesses and protrusions on the side wall surface, but it is also possible to use a configuration to enable the linear portions 10 to be visually distinguished by using difference in light reflection properties produced by different serration processes, without providing surface recesses and protrusions on the side wall surface. In other words, the reflection properties of the surfaces of the straight portions 11 and the plurality of inclined pattern portions 12 are preferably different from the reflection properties of the surfaces surrounding the linear portions 10. At this time, preferably, the reflection properties are, for example, diffuse reflection properties, and the extent of the diffuse reflection of the surface of the straight portions 11 and the plurality of inclined pattern portions 12 is higher compared with the extent of the diffuse reflection of the surfaces surrounding the linear portions 10. The diffuse reflection properties can be adjusted by making the surface roughness of the straight portions 11 and the plurality of inclined pattern portions 12 greater compared with the surface roughness of the surroundings of the linear portions 10. Reflection properties include using different reflection orientations, as well as using difference in reflection by diffuse reflection. For example, the straight portions 11 and the plurality of inclined pattern portions 12 can be given flat and smooth surfaces, and the orientation of the smooth surfaces inclined so that the orientation is different from the orientation of the surfaces surrounding the linear portions 10.

If the linear portions 10 are formed with grooves or protrusions, the surfaces of the straight portions 11 and the plurality of inclined pattern portions 12 do not have to be serration processed.

By providing the plurality of linear portions 10 configured as described above in the tire circumferential direction with the gap D therebetween, the pattern as illustrated in FIG. 4A, FIG. 4B, or FIG. 4C is formed. Here, in each of the plurality of linear portions 10, the plurality of inclined pattern portions 12 is provided superimposed at an inclination on the straight portion 11, so it is possible to give a viewer an illusion due to obtaining a perception that each of the plurality of linear portions 10 appears inclined in the tire circumferential direction. Specifically, as illustrated in FIG. 4B, if the inclination direction of one inclined pattern portion 12 on one linear portion 10 is the same as the inclination direction of an inclined pattern portion 12 in another linear portion 10 that is adjacent to the inclined pattern portion 12 in the tire circumferential direction, a visual illusion effect can be obtained in which the linear portions 10 appear to be wavy in the tire circumferential direction. Also, as illustrated in FIG. 4C, if the inclination direction of one inclined pattern portion 12 in one linear portion 10 is inverted about the tire circumferential direction with respect to the inclination direction of an inclined pattern portion 12 of another linear portion 10 that is adjacent to the inclined pattern portion 12 in the tire circumferential direction, it is possible to obtain a visual illusion effect in which a portion between two linear portions 10 that are adjacent to each other in the tire circumferential direction appears to be open. Even if the inclination direction of all the inclined pattern portions 12 of the plurality of linear portion 10 is the same, it is possible for a viewer to obtain a visual illusion caused by obtaining the perception that the plurality of linear portion 10 appear to be inclined in the tire circumferential direction.

Therefore, in the tire 1 according to this embodiment, it is possible to make the unevenness appearing on the side wall surface sufficiently inconspicuous to a person viewing the side wall surface of the tire 1. Also, in the tire 1 according to this embodiment, the plurality of linear portions 10 that include a straight portion 11 and a plurality of inclined pattern portions 12 can form the pattern by the simple configuration of providing a gap in the tire circumferential direction without the linear portions 10 intersecting each other, so, for example, compared with the conventional technology in which a moire pattern is formed by intersecting a first ridge group and a second ridge group that each include a plurality of ridges throughout the tire circumferential direction, it is possible to reduce the area over which the side wall surface is processed, and simplify the content of the processing.

The pattern of the side pattern display area 3a may be formed by providing the plurality of linear portions extending in the same direction along the tire circumferential direction, without intersecting each other and with a gap therebetween in the tire radial direction. In this case, the ends on the first side in the tire radial direction of each of the plurality of inclined pattern portions of the linear portion are provided aligned in the tire circumferential direction, and the ends on the second side in the tire radial direction are provided aligned in the tire circumferential direction. Also, between each of the plurality of inclined pattern portions of the linear portion and the inclined pattern portion provided on another linear portion that is adjacent in the tire radial direction, the ends on the first side in the tire circumferential direction are provided aligned in the tire radial direction, and the ends on the second side in the tire circumferential direction are aligned in the tire radial direction.

### Second Embodiment

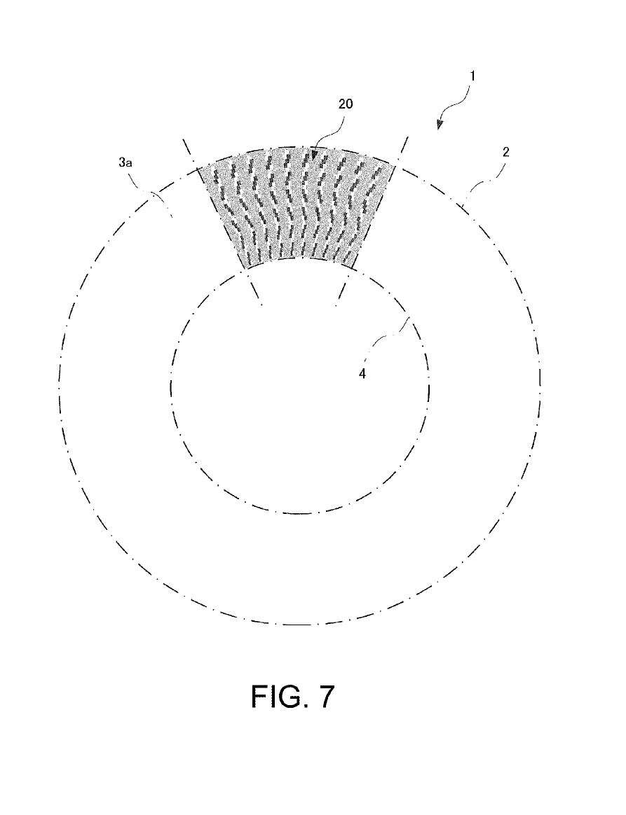

FIG. 7 illustrates the surface of a side wall portion 3 of a tire 1 according to a second embodiment.

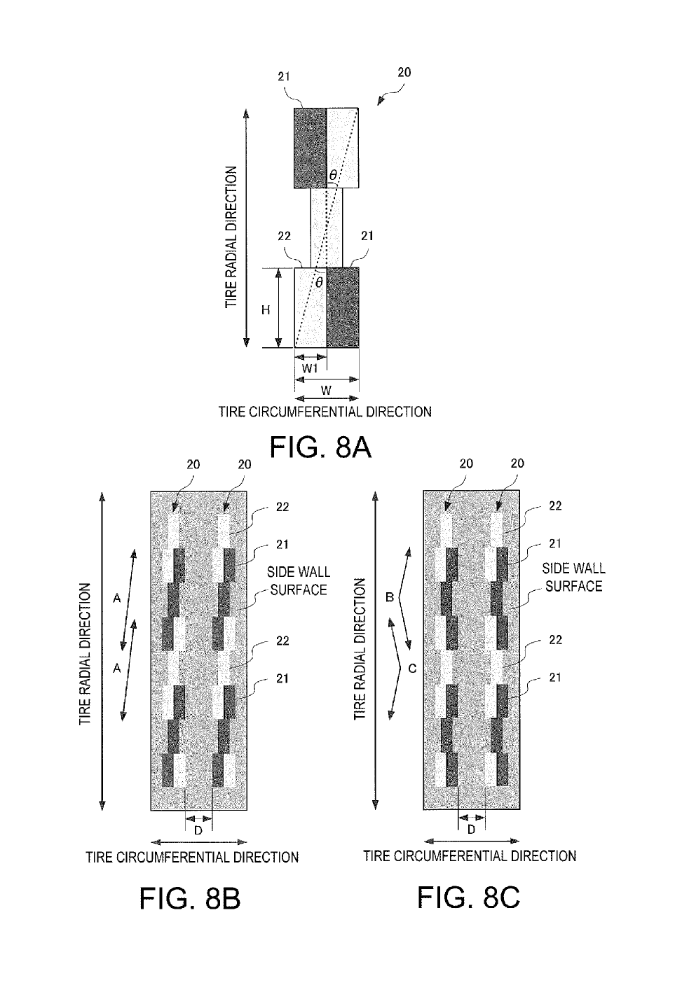

The configuration of the tire 1 according to the second embodiment is the same as the configuration of the tire 1 according to the first embodiment as illustrated in FIG. 2. The point of difference between the tire 1 according to the second embodiment and the tire 1 according to the first embodiment is that each of a plurality of inclined pattern portions 21, 22 (see FIG. 8) that constitute linear portions 20 is formed as a plurality of small 4-sided shaped areas. By giving these small areas different reflection properties due to surface roughness, it is possible to visually recognize the areas of the inclined pattern portions 21, 22 in contrast to the surrounding areas. Therefore, in FIGS. 7 to 14, different reflection properties are represented by contrasting density such as white, black, gray, and the like.

The following is a specific description of the linear portions 20, referring to FIGS. 8A to 8C. The linear portion 20 includes a plurality of first inclined pattern portions 21 and a plurality of second inclined pattern portions 22, and is formed extending in the tire radial direction by disposing the first inclined pattern portions 21 and the second inclined pattern portions 22 alternately in the tire radial direction. Each of the first inclined pattern portions 21 and second inclined pattern portions 22 is formed by arranging one side of a plurality (in this embodiment, three) of small 4-sided shaped areas along the tire radial direction. In the example illustrated in FIG. 8B, the first inclined pattern portion 21 is a portion formed by arranging three 4-sided shapes inclined in the direction of the straight line A (black areas in the figure). In the example illustrated in FIG. 8B, the second inclined pattern portion 22 is a portion formed by arranging three 4-sided shapes inclined in the direction of the straight line A (white areas in the drawing). Here, a 4-sided shape refers to a rectangular shape having four sides, such as for example a square, rectangle, or the like, and includes shapes in which the four corners formed by the four sides are curved or chamfered at an incline. Also, the four sides may be all straight lines, or at least one side may be curved. In addition, preferably, the height H in the tire radial direction of each small area is formed greater than the width W1 in the tire circumferential direction. Specifically, for example, preferably, the height H in the tire radial direction is formed within the range W1<H<3×W1.

Each small area may be formed from protrusions or recesses, the same as for the straight portion 11 and the plurality of inclined pattern portions 12 according to the first embodiment, or they may be formed by serration processing.

As illustrated in FIGS. 8A to 8C, the three 4-sided shaped small areas from which the first inclined pattern portions 21 and the second inclined pattern portions 22 are configured are arranged extending in one direction adjacent to each other in the tire radial direction. In other words, when the side wall surface is viewed along the normal line direction of the side wall surface, the small area of the three small areas located in the center in the tire radial direction and the tire circumferential direction is in line contact with the other two small areas of the three small areas along the tire radial direction.

Also, when the side wall surface is viewed along the normal line direction of the side wall surface, the first inclined pattern portions 21 and the second inclined pattern portions 22 are in line contact with each other along the tire radial direction. Specifically, as illustrated in FIG. 8A, the small area of the three small areas of the second inclined pattern portions 22 located in the center in the tire radial direction and the tire circumferential direction is in line contact with the small area of the three small areas of the first inclined pattern portions 21 adjacent to the second inclined pattern portions 22 in the tire radial direction located on the outer side in the tire radial direction or the inner side in the tire radial direction. On the other hand, as illustrated in FIG. 8B and FIG. 8C, the small area of the three small areas of the first inclined pattern portion 21 located in the center in the tire radial direction and the tire circumferential direction is in line contact with the small area of the three small areas of the second inclined pattern portion 22 adjacent to the first inclined pattern portion 21 in the tire radial direction located on the outer side in the tire radial direction or the inner side in the tire radial direction.

In addition, each of the first inclined pattern portions 21 and the second inclined pattern portions 22 is formed extending in a direction that is inclined with respect to the tire radial direction, by arranging the three small areas in a step form along the tire radial direction. Specifically, the small area of the three small areas located on the outer side in the tire radial direction (the top side in FIG. 8A) and the small area of the three small areas located on the inner side in the tire radial direction (the bottom side in FIG. 8A) are arranged so as to be shifted in the tire circumferential direction with respect to the small area of the three small areas located in the center. In this case, as illustrated in FIG. 8B, each of the first inclined pattern portions 21 and the second inclined pattern portions 22 may be formed extending along the straight line A which is inclined with respect to the tire radial direction, or, as illustrated in FIG. 8C, may be formed extending along the bent line B or the bent line C. Here, the absolute value of the inclination angle θ of each of the first inclined pattern portions 21 and the second inclined pattern portions 22 is preferably greater than 0°, and less than or equal to 45°. Here, describing the inclination angle θ of each of the first inclined pattern portions 21 and the second inclined pattern portions 22 with reference to the second inclined pattern portions 22 illustrated in FIG. 8A, the inclination angle θ refers to the acute angle formed by the line connecting the center of the second inclined pattern portion 22 with the corner that is located furthest from the center of the second inclined pattern portion 22 in the tire radial direction and the tire circumferential direction from among the corners that constitute each of the three small areas of the second inclined pattern portion 22, and a line passing through the center parallel with the tire radial direction.

Also, the three small areas that constitute each of the first inclined pattern portions 21 and the second inclined pattern portions 22 are formed with a different surface roughness from the surrounding areas, and have the same surface roughness as each other. In addition, in the tire 1 according to this embodiment, a portion of the side wall surface apart from the pattern is formed having a specific surface roughness. Here, the surface roughness is the arithmetic mean roughness as prescribed in Japanese Industrial Standard (JIS) B 0601.

In this embodiment, in order to make the unevenness appearing on the side wall surface inconspicuous, preferably, the surface roughness Ra of the portion of the side wall surface apart from the pattern satisfies the relationship Ra1>Ra>Ra2, where Ra1 is the surface roughness of the first inclined pattern portion 21, and Ra2 is the surface roughness of the second inclined pattern portion 22. Preferably, the surface roughness Ra1 of the first inclined pattern portion 21 is, for example, from 3000 to 8000 μm. Also, preferably, the surface roughness Ra of the portion of the side wall surface apart from the pattern is, for example, from 800 to 2500 μm. In addition, the surface roughness Ra2 of the second inclined pattern portions 22 is preferably, for example, from 250 to 600 μm.

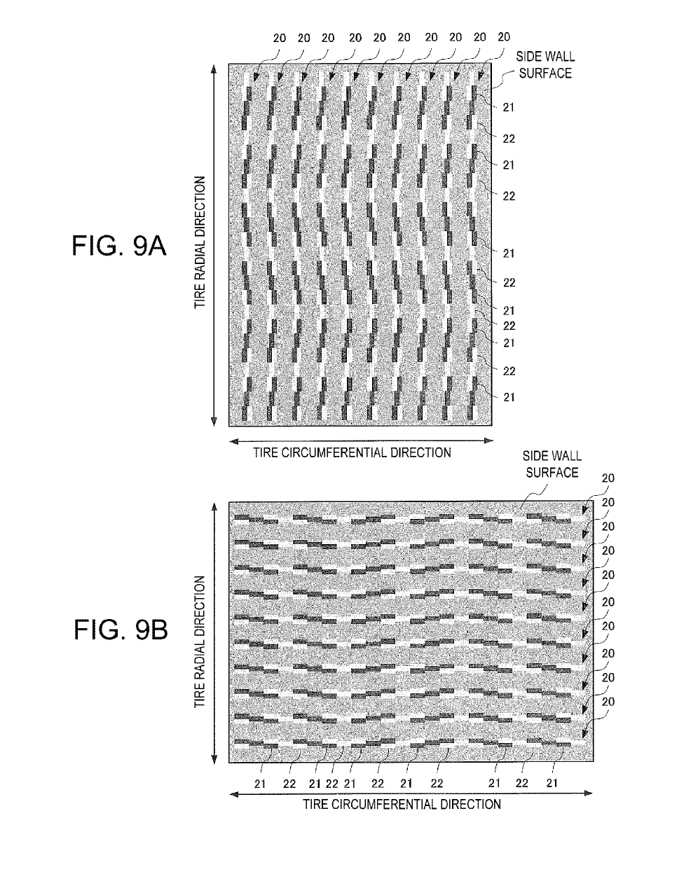

By providing the plurality of linear portions 20 configured as described above with gaps in the tire circumferential direction, the pattern as illustrated in FIG. 9A is formed. In this pattern, when the first inclined pattern portions 21 and the second inclined pattern portions 22 are provided alternately along the tire radial direction, the inclination attitude of the second inclined pattern portions 22 changes. In this case, the inclination direction of the first inclined pattern portions 21 is inverted in the tire circumferential direction every time a predetermined number of first inclined pattern portions 21 is provided (two in the example in FIG. 9A). In this case, it is possible to give the viewer a visual illusion caused by obtaining the visual illusion effect of the plurality of linear portions 20 appearing to bend and wave in the tire circumferential direction.

Therefore, in the tire 1 according to this embodiment, it is possible to make the unevenness appearing on the side wall surface sufficiently inconspicuous to a person viewing the side wall surface of the tire 1.

Also, as illustrated in FIG. 9B, each of the plurality of linear portions 20 extending in the tire circumferential direction may be provided with gaps in the tire radial direction. In this case, it is possible to give the viewer a visual illusion caused by the visual illusion effect of the plurality of linear portions 20 appearing to bend and wave in the tire radial direction.

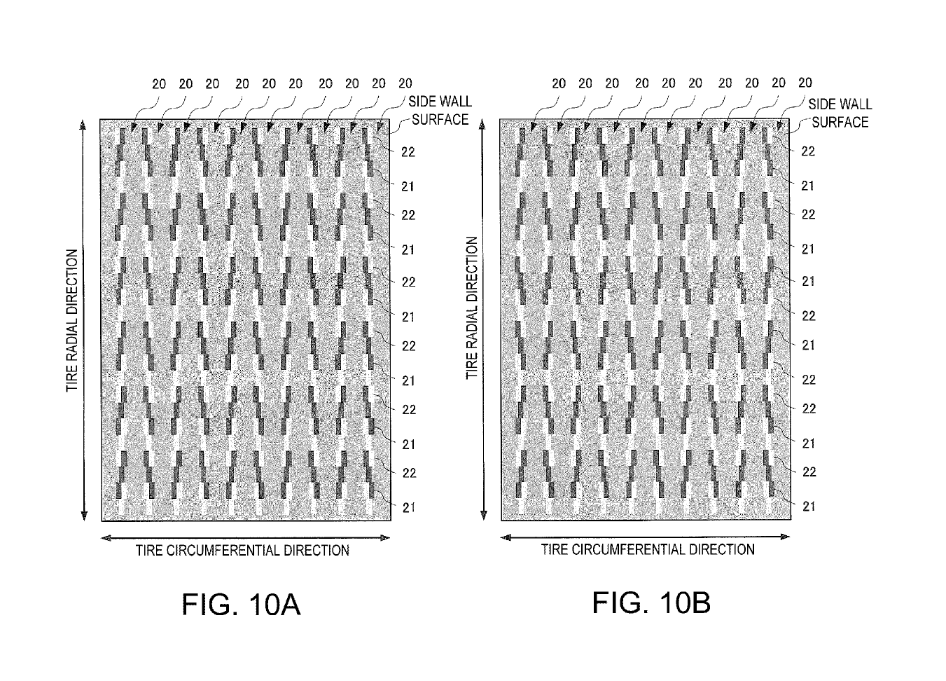

Next, other examples of the pattern illustrated in FIG. 9 are described with reference to FIG. 10. FIGS. 10A and 10B are explanatory views of other examples of the pattern illustrated in FIG. 9.

The patterns illustrated in FIGS. 10A and 10B are formed by providing the plurality of linear portions 20 extending in the same direction as each other along the tire radial direction, without intersecting each other, and providing gaps therebetween in the tire circumferential direction. Also, between one linear portion 20 and another linear portion 20 that is adjacent to the linear portion 20 in the tire circumferential direction, the inclination directions of the first inclined pattern portion 21 and the second inclined pattern portion 22 are inverted about the tire circumferential direction.

In the pattern illustrated in FIG. 10A, the first inclined pattern portions 21 and the second inclined pattern portions 22 of one linear portion 20 are both provided inclined in the same direction. In this case, it is possible to give a visual illusion to a viewer caused by obtaining the visual illusion effect that one linear portion 20 and another linear portion 20 that is adjacent to the linear portion 20 in the tire circumferential direction are approaching or separating in the tire radial direction. As a result, it is possible to make the unevenness appearing on the side wall portion sufficiently inconspicuous.

Also, in the pattern illustrated in FIG. 10B, one linear portion 20 is provided so that every time two first inclined pattern portions 21 are provided along the tire radial direction, the inclination direction of the first inclined pattern portions 21 is inverted about the tire circumferential direction. In this case, it is possible to give a visual illusion to a viewer caused by obtaining the visual illusion effect that a portion between one linear portion 20 and another linear portion 20 that is adjacent to the linear portion 20 in the tire circumferential direction appears to open. As a result, it is possible to make the unevenness appearing on the side wall portion sufficiently inconspicuous.

The same visual illusion effect as described above can be obtained by switching the tire circumferential direction and the tire radial direction illustrated in FIGS. 10A and 10B, and forming the same patterns as described above using the plurality of linear portions 20 extending in the tire circumferential direction.

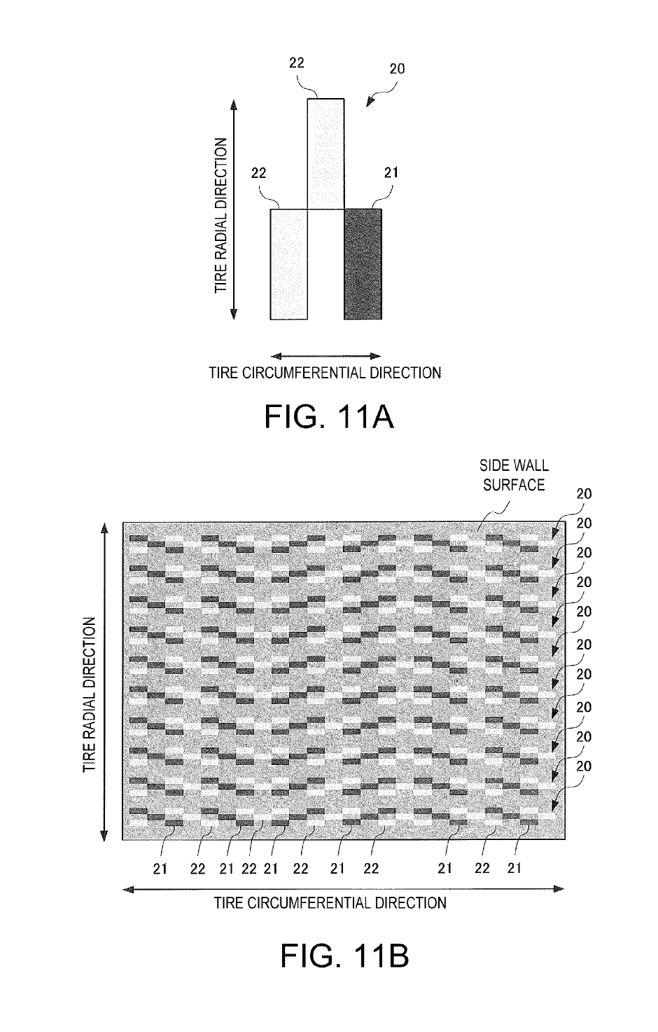

Next, another example of the linear portion 20 illustrated in FIG. 8 is described with reference to FIG. 11. FIGS. 11A and 11B are explanatory views of another example of the linear portion 20 illustrated in FIG. 8.

In the example illustrated in FIG. 8A, the small area of the three small areas located in the center in the tire circumferential direction and the tire radial direction is in line contact in the tire radial direction with the other two small areas of the three small areas, but as illustrated in FIG. 11A, the small area of the three small areas located in the center in the tire circumferential direction and the tire radial direction may be provided in point contact in the tire radial direction with the other two small areas of the three small areas. In FIG. 11A, the corners of two small areas of the three small areas which are second inclined pattern portions 22 are in point contact. In this case, as illustrated in FIG. 11B, if the plurality of linear portions 20 that extend in the tire circumferential direction is provided with gaps in the tire radial direction, it is possible to give a viewer a visual illusion caused by obtaining a visual illusion effect in which the plurality of linear portions 20 are bending and waving in the tire radial direction, the same as the pattern in FIG. 9B. Therefore, it is possible to make the unevenness appearing on the side wall surface sufficiently inconspicuous.

Preferably, the small areas are in line contact in order to increase the visual illusion effect compared with the case where the small areas are in point contact.

### Third Embodiment

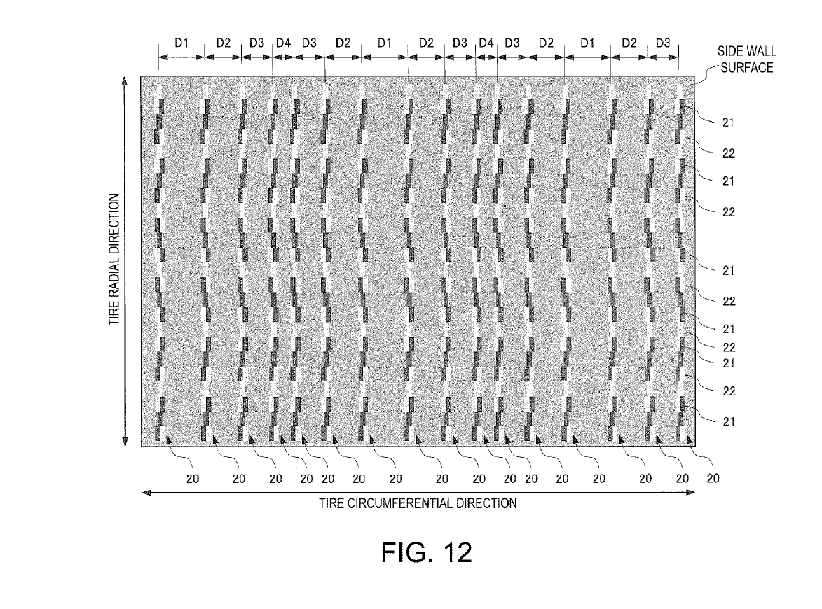

FIG. 12 illustrates an example of pattern formed on a side wall surface of a pneumatic tire 1 according to a third embodiment.

The configuration of the tire 1 according to the third embodiment is the same as the configuration of the tire 1 according to the above embodiments, in other words, the first embodiment and the second embodiment. The point of difference of the tire 1 according to the third embodiment from the tires 1 according to the above embodiments is that the gaps D1, D2, D3, and D4 in the tire circumferential direction between the plurality of linear portions 20 that extend in the tire radial direction vary periodically at the same position in the tire radial direction, as illustrated in FIG. 12.

Specifically describing with reference to FIG. 12, the gap between one linear portion 20 and another linear portion 20 that is adjacent to the linear portion 20 in the tire circumferential direction becomes smaller for each linear portion 20 provided along the tire circumferential direction in the order D1, D2, D3, and D4, and thereafter becomes larger in the order D4, D3, D2, and D1, and this fluctuation is periodically repeated. The fluctuation in the gaps D1, D2, D3, and D4 may vary in accordance with a sine wave, a rectangular wave, a triangular wave, or a saw tooth wave, and the like. Also, preferably, the relationship between the width W in the tire circumferential direction of one linear portion 20 and the gaps D1, D2, D3, and D4 between the plurality of linear portions 20 is, for example, W<D1<D2<D3<D4<5×W.

In this case, the pattern illustrated in FIG. 12 appears to be floating in three-dimensions due to a visual illusion effect at the position where the gap between each of the linear portions 20 is a maximum, or when the gap is D1. Therefore, it is possible to make the unevenness that appears on the side wall surface more inconspicuous.

Even if the tire circumferential direction and the tire radial direction illustrated in FIG. 12 are switched, and the pattern is configured with the gaps in the tire radial direction between the plurality of linear portions 20 that extend in the tire circumferential direction varying periodically, the three-dimensional visual illusion effect can be obtained, so it is possible to make the unevenness appearing on the side wall surface more inconspicuous. Also, if the gaps between the plurality of linear portions 10 of the first embodiment are varied periodically, the same visual illusion effect as described above can be obtained.

### Fourth Embodiment

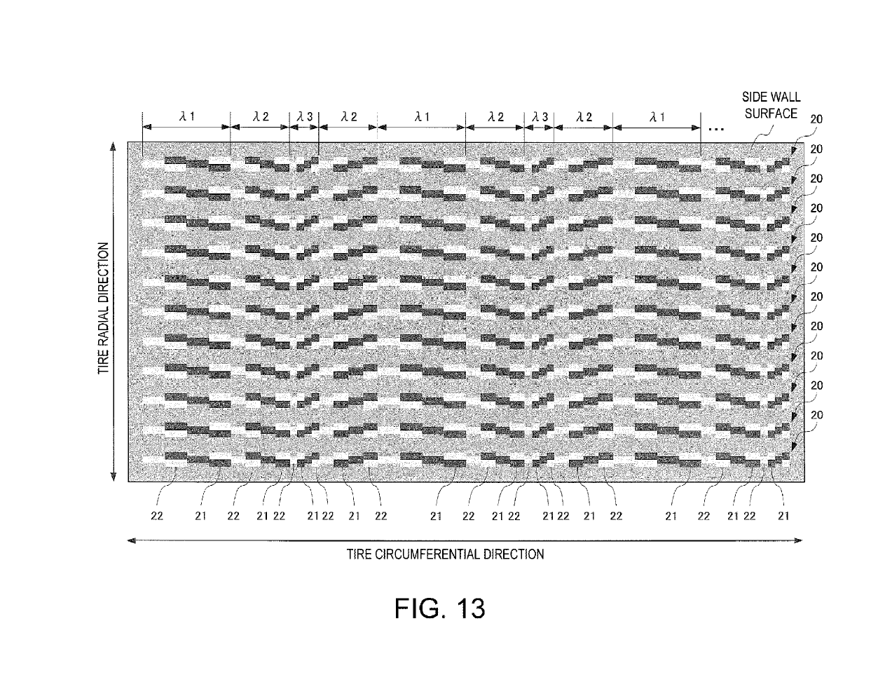

FIG. 13 illustrates an example of pattern formed on a side wall surface of a tire 1 of a fourth embodiment.

The configuration of the tire 1 according to the fourth embodiment is the same as the configuration of the tire 1 according to the above embodiments, in other words, the tire 1 according to the first to third embodiments. The point of difference of the tire 1 according to the fourth embodiment from the tires 1 according to the above embodiments is that the length in the tire circumferential direction of the plurality of first inclined pattern portions 21 varies periodically, as illustrated in FIG. 13.

Specifically describing with reference to FIG. 13, when the length of four small areas that are lined up continuously in the tire circumferential direction, from among a plurality of small areas (six in the example illustrated in FIG. 13) that includes three small areas that constitute the first inclined pattern portion 21, is λ1, λ2, and λ3, the lengths λ, λ2, and λ3 become smaller in the order λ1, λ2, and λ3, and then become larger in the order λ3, λ2, and λ1, and this fluctuation is periodically repeated. In this case, the length in the tire circumferential direction of the first inclined pattern portion 21 that includes the plurality of small areas varies periodically in accordance with the fluctuation in the lengths λ1, λ2, and λ3. Here, the fluctuation in the lengths λ1, λ2, and λ3 may be fluctuation in accordance with a sine wave, a rectangular wave, a triangular wave, or a saw tooth wave, and the like.

In this case, in the pattern illustrated in FIG. 13, a visual illusion effect can be obtained in which at the position where the length in the tire circumferential direction of the four small areas that are lined up continuously in the tire circumferential direction is the minimum λ3, the linear portion 20 appears to be recessed in the tire radial direction, and at the position where the length is the maximum λ1, the linear portion 20 appears to be protruding in the tire radial direction. Therefore, it is possible to make the unevenness that appears on the side wall surface more inconspicuous.

Even if the length in the tire circumferential direction of each of the plurality of second inclined pattern portions 22 is also configured to vary periodically, the same visual illusion effect as described above can be obtained.

Also, if the tire circumferential direction and the tire radial direction illustrated in FIG. 13 are switched, and the pattern is formed using the plurality of linear portions 20 extending in the tire radial direction, and the length in the tire radial direction of the first inclined pattern portions 21 or the second inclined pattern portions 22 is configured to vary periodically, the same visual illusion effect as described above can be obtained, so it is possible to make the unevenness appearing on the side wall surface more inconspicuous.

### Fifth Embodiment

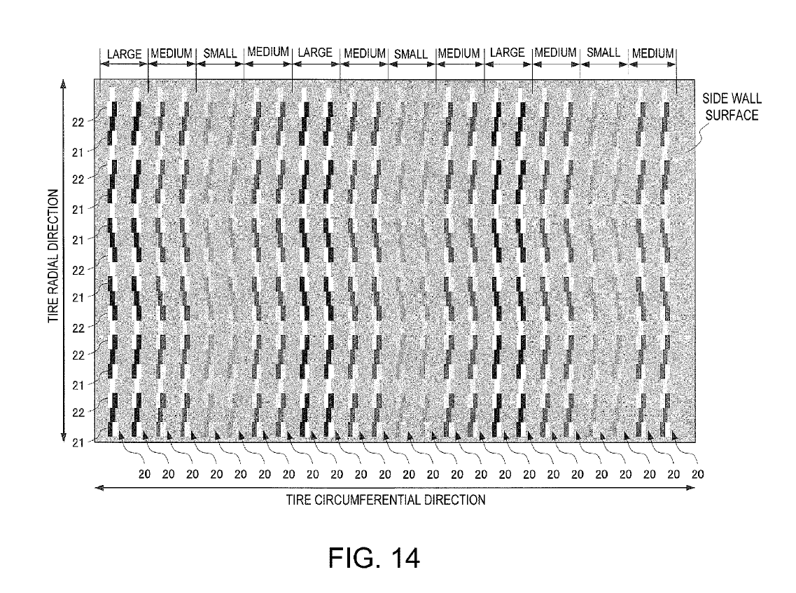

FIG. 14 illustrates an example of pattern formed on a side wall surface of a pneumatic tire 1 according to a fifth embodiment.

The configuration of the tire 1 according to the fifth embodiment is the same as the configuration of the tire 1 according to the above embodiments, in other words, the first to fourth embodiments. The point of difference of the tire 1 according to the fifth embodiment from the embodiments as described above is that the difference in the surface roughness Ra1 of the first inclined pattern portions 21 and the surface roughness Ra2 of the second inclined pattern portions 22 is different every plurality of linear portions 20, and varies periodically in the tire circumferential direction, as shown in FIG. 14.

Specifically describing with reference to FIG. 14, in one linear portion 20, if the difference in the surface roughness Ra1 of the first inclined pattern portions 21 and the surface roughness Ra2 of the second inclined pattern portions 22 is Ra3, the difference Ra3 becomes smaller in the order of large, medium, and small every two linear portions 20 provided in the tire circumferential direction, and then becomes larger in the order of small, medium, large, and this periodic variation is repeated. Here, the variation in the difference Ra3 may vary in accordance with a sine wave, a rectangular wave, a triangular wave, or a saw tooth wave, and so on.

In the pattern illustrated in FIG. 14, the visual illusion effect of the linear portion 20 is different at each position with a different surface roughness difference Ra3. Specifically, compared with a linear portion 20 with small surface roughness difference Ra3, the visual illusion effect that a linear portion 20 with a greater surface roughness difference Ra3 appears to be further floating can be obtained. Therefore, it is possible to make the unevenness that appears on the side wall surface more inconspicuous.

In this embodiment, it was described that every time two linear portions 20 are provided in the tire circumferential direction the surface roughness difference Ra3 varies, but it may also be configured so that every time one linear portion 20 is provided along the tire circumferential direction the surface roughness difference Ra3 varies. Also, the difference Ra3 may be varied every time a fixed number, such as three or more, of the linear portions is provided.

Also, if the tire circumferential direction and the tire radial direction in FIG. 14 are switched, and the plurality of linear portions 20 is provided with gaps in the tire radial direction, preferably, the surface roughness difference Ra3 is configured so that it varies periodically along the tire radial direction.

Also, preferably, the gaps D1, D2, D3, and D4 between the plurality of linear portions are also varied synchronously with the variation in the surface roughness difference Ra3. Specifically, at the position where the surface roughness difference Ra3 is the minimum, the gap between the plurality of linear portions 20 may be a minimum or a maximum, and at the position where the surface roughness difference Ra3 is a maximum, the gap between the plurality of linear portions 20 may be a maximum or a minimum. In this case, the three-dimensional visual illusion effect obtained from the pattern is more pronounced.

### EXAMPLES

In order to investigate the effect of the embodiments, the tire 1 illustrated in FIG. 2 (size: 145R126PR) was fabricated making various changes to the patterns on the side wall surface. The tires fabricated were viewed by 100 people, to evaluate the visibility of the unevenness caused by the overlapped portion 5e (hereafter referred to as the BPS splice unevenness) of the carcass layer 5 which existed on the actual side wall surfaces.

The following scores were used for the evaluation results.

Score 110: 95% or more of the observers were unable to clearly recognize the BPS splice unevenness.

Score 108: 90% or more and less than 95% of the observers were unable to clearly recognize the BPS splice unevenness.

Score 106: 80% or more and less than 90% of the observers were unable to clearly recognize the BPS splice unevenness.

Score 104: 70% or more and less than 80% of the observers were unable to clearly recognize the BPS splice unevenness.

Score 102: 60% or more and less than 70% of the observers were unable to clearly recognize the BPS splice unevenness.

Score 100: 50% or more and less than 60% of the observers were unable to clearly recognize the BPS splice unevenness.

Score 97: less than 50% of the observers were unable to clearly recognize the BPS splice unevenness.

The side wall surfaces used in the test and the evaluation results are shown in the following table.

The Comparative Example was a tire with no side pattern display area 3a. In Working Example 1, the pattern of the second embodiment that included a plurality of linear portions 20 was provided in the side pattern display area 3a.

In Working Example 2, the plurality of linear portions 20 which were each extending in the tire radial direction were provided with gaps in the tire circumferential direction, and the gaps in the tire circumferential direction between each of the plurality of linear portions 20 were varied periodically.

Also, in Working Example 3, the plurality of linear portions 20 which were each extending in the tire circumferential direction was provided with gaps in the tire radial direction, and the length in the tire circumferential direction of the first inclined pattern portions 21 was varied periodically.

In addition, in Working Examples 4 to 6, the size relationship between the surface roughness Ra of the area without the pattern, the surface roughness Ra1 of the first inclined pattern portions 21, and the surface roughness Ra2 of the second inclined pattern portions 22 were formed different from each other.

In addition, in Working Example 7, the difference in the surface roughness Ra1 of the first inclined pattern portions 21 and the surface roughness Ra2 of the second inclined pattern portions 22 was formed so that it varied periodically.

TABLE 1

| | Comparative | Working | Working | Working | Working | Working | Working | Working |
|---|---|---|---|---|---|---|---|---|
| | Example | Example 1 | Example 2 | Example 3 | Example 4 | Example 5 | Example 6 | Example 7 |
| Presence or Absence of | Absent | Present | Present | Present | Present | Present | Present | Present |
| Pattern | | | | | | | | |
| Periodic variation of | — | None | Present | Present | Present | Present | Present | Present |
| gap between linear | | | | | | | | |
| portions | | | | | | | | |
| Periodic variation of | — | None | None | Present | Present | Present | Present | Present |
| length of inclined | | | | | | | | |
| pattern portions | | | | | | | | |
| Surface roughness of | — | — | — | — | 100 | 800 | 800 | 800 |
| area without pattern | | | | | | | | |
| (μm) | | | | | | | | |
| Surface roughness of | — | — | — | — | 3000 | 500 | 3000 | 3000 |
| first inclined pattern | | | | | | | | |
| portions (μm) | | | | | | | | |
| Surface roughness of | — | — | — | — | 600 | 250 | 250 | 250 |
| second inclined pattern | | | | | | | | |
| portions (μm) | | | | | | | | |
| Periodic variation of | — | None | None | None | None | None | None | Present |
| difference in surface | | | | | | | | |
| roughness | | | | | | | | |
| Appearance performance | 97 | 100 | 102 | 104 | 104 | 104 | 108 | 110 |

From a comparison of the Comparative Example and Working Example 1, it can be seen that the evaluation results are improved by providing the pattern with the linear portions 20. This may be due to the visual illusion effect of the pattern configured from the plurality of linear portions 20.

Also, from a comparison of Working Examples 1 and 2, it can be seen that the evaluation results are improved by forming the gap in the tire circumferential direction between the linear portions 20 varying periodically.

In addition, from a comparison of Working Examples 2 and 3, it can be seen that the evaluation results are improved by forming the length of the first inclined pattern portions 21 in the tire circumferential direction varying periodically.

Furthermore, from a comparison of Working Examples 3 to 6, it can be seen that the evaluation results are improved by forming the pattern so that the surface roughness Ra of the area of the side wall surface without the pattern has the relationship Ra1>Ra>Ra2, where Ra1 is the surface roughness of the first inclined pattern portions 21, and Ra2 is the surface roughness of the second inclined pattern portions 22.

Also, from a comparison of Working Examples 6 and 7, it can be seen that the evaluation results are improved by forming the pattern so that the difference in the surface roughness Ra1 of the first inclined pattern portions 21 and the surface roughness Ra2 of the second inclined pattern portions 22 varies periodically.

The pneumatic tire of the present technology was described in detail above. However, it should be understood that the present technology is not limited to the above embodiments, but may be improved or modified in various ways so long as these improvements or modifications remain within the scope of the present technology.

1. A pneumatic tire comprising:
a tread portion;
a bead portion; and
a side wall portion having a pattern that is visually distinguished from a surrounding area thereof due to recesses and protrusions or light reflection properties of the side wall surface, the pattern being configured by providing a plurality of linear portions extending without intersecting each other along a first direction A that is either a tire radial direction or a tire circumferential direction with gaps in a second direction B that is either the tire radial direction or the tire circumferential direction,
each of the plurality of linear portions including a plurality of inclined pattern portions that extend in a direction that is inclined with respect to the direction A, and
each of the plurality of inclined pattern portions being provided so that the positions of ends of the inclined pattern portions on a first side in the direction B are aligned with each other in the direction A, and the positions of ends of the inclined pattern portions on a second side in the direction B are aligned with each other in the direction A, and, between the inclined pattern portions provided on linear portions that are adjacent in the direction B, the positions of the ends of the inclined pattern portions on the adjacent linear portions on the first side in the direction A are aligned in the direction B, and the positions of the ends of the inclined pattern portions on the adjacent linear portions on the second side in the direction A are aligned in the direction B.

2. The pneumatic tire according to claim 1, wherein the gaps in the direction B of the plurality of linear portions vary periodically.

3. The pneumatic tire according to claim 1, wherein the length in the direction A of the plurality of inclined pattern portions varies periodically.

4. The pneumatic tire according to claim 1, wherein each of the plurality of inclined pattern portions has a surface roughness that is different from that of the surrounding area, and, is formed by arranging a plurality of small 4-sided shaped areas each having the same surface roughness in a direction that is inclined with respect to the direction A.

5. The pneumatic tire according to claim 4, wherein the small areas are rectangular-shaped areas, and each of the inclined pattern portions is formed by arranging one side of each of the small areas along the direction A and arranging the plurality of small areas in a step form along the direction A, and
the surface roughness Ra of a wall surface without the pattern satisfies the relationship Ra1>Ra>Ra2, where Ra1 is a surface roughness of first inclined pattern portions from among the plurality of inclined pattern portions, and Ra2 is a surface roughness of second inclined pattern portions that are adjacent to the first inclined pattern portions in the direction A.

6. The pneumatic tire according to claim 5, wherein the plurality of small areas is in point contact or line contact with each other when the side wall surface is viewed.

7. The pneumatic tire according to claim 5, wherein a difference between the surface roughness Ra1 of the first inclined pattern portions and the surface roughness Ra2 of the second inclined pattern portions is different every plurality of linear portions and varies periodically along the direction B.

8. The pneumatic tire according to claim 1, wherein in addition to the inclined pattern portions, the linear portions include a straight portion that extends in a straight line along the direction A, and the inclined pattern portions intersect with the straight portion, and
the straight portion and the inclined pattern portions are provided protruding from or recessed into the side wall surface.

9. The pneumatic tire according to claim 1, wherein in addition to the inclined pattern portions, the linear portions include a straight portion that extends in a straight line along the direction A, and the inclined pattern portions intersect with the straight portion, and
the light reflection properties of the surfaces of the straight portion and the inclined pattern portions are different from the light reflection properties of the surfaces around the linear portions.

10. The pneumatic tire according to claim 9, wherein the light reflection properties are diffuse reflection properties, and the extent of diffuse reflection of the surfaces of the straight portion and the inclined pattern portions is greater than the extent of diffuse reflection of a surface around the linear portions.

11. The pneumatic tire according to claim 10, wherein the surface roughness of the straight portion and the inclined pattern portions is greater than a surface roughness of a surface around the linear portions.

12. The pneumatic tire according to claim 2, wherein the length in the direction A of the plurality of inclined pattern portions varies periodically.

13. The pneumatic tire according to claim 2, wherein each of the plurality of inclined pattern portions has a surface roughness that is different from that of the surrounding area, and, is formed by arranging a plurality of small 4-sided shaped areas each having the same surface roughness in a direction that is inclined with respect to the direction A.

14. The pneumatic tire according to claim 3, wherein each of the plurality of inclined pattern portions has a surface roughness that is different from that of the surrounding area, and, is formed by arranging a plurality of small 4-sided shaped areas each having the same surface roughness in a direction that is inclined with respect to the direction A.

15. The pneumatic tire according to claim 6, wherein the difference between the surface roughness Ra1 of the first inclined pattern portions and the surface roughness Ra2 of the second inclined pattern portions is different every plurality of linear portions and varies periodically along the direction B.

16. The pneumatic tire according to claim 2, wherein in addition to the inclined pattern portions, the linear portions include a straight portion that extends in a straight line along the direction A, and the inclined pattern portions intersect with the straight portion, and
the straight portion and the inclined pattern portions are provided protruding from or recessed into the side wall surface.

17. The pneumatic tire according to claim 3, wherein in addition to the inclined pattern portions, the linear portions include a straight portion that extends in a straight line along the direction A, and the inclined pattern portions intersect with the straight portion, and
the straight portion and the inclined pattern portions are provided protruding from or recessed into the side wall surface.

18. The pneumatic tire according to claim 2, wherein in addition to the inclined pattern portions, the linear portions include a straight portion that extends in a straight line along the direction A, and the inclined pattern portions intersect with the straight portion, and
the light reflection properties of the surfaces of the straight portion and the inclined pattern portions are different from the light reflection properties of the surfaces around the linear portions.

19. The pneumatic tire according to claim 3, wherein in addition to the inclined pattern portions, the linear portions include a straight portion that extends in a straight line along the direction A, and the inclined pattern portions intersect with the straight portion, and
the light reflection properties of the surfaces of the straight portion and the inclined pattern portions are different from the light reflection properties of the surfaces around the linear portions.

20. The pneumatic tire according to claim 19, wherein:
the light reflection properties are diffuse reflection properties, and the extent of diffuse reflection of the surfaces of the straight portion and the inclined pattern portions is greater compared with the extent of diffuse reflection of the surface around the linear portions; and
the surface roughness of the straight portion and the inclined pattern portions is greater compared with the surface roughness of the surface around the linear portions.
